(19) United States
(12) Patent Application Publication
(10) Pub. No.: US 2017/0106897 A1
(43) Pub. Date: Apr. 20, 2017

(54) STEERING COLUMN FOR A MOTOR VEHICLE

(71) Applicants: ThyssenKrupp Presta AG, Eschen (LI); ThyssenKrupp AG, Essen (DE)

(72) Inventor: Fabian PÖTZL, Feldkirch (AT)

(73) Assignees: ThyssenKrupp Presta AG, Eschen (LI); ThyssenKrupp AG, Essen (DE)

(21) Appl. No.: 15/129,437

(22) PCT Filed: Mar. 18, 2015
(86) PCT No.: PCT/EP2015/055670

§ 371 Date: Sep. 27, 2016

(30) Foreign Application Priority Data
Mar. 28, 2014 (DE) 10 2014 104 350.2

(51) Int. Cl. B62D 1/19

(52) U.S. Cl. CPC B62D 1/195

(57) ABSTRACT

A steering column for a motor vehicle may include a mounting support with at least one open elongated hole and at least one sliding capsule arranged in the open elongated hole. The sliding capsule may be secured on a chassis of a motor vehicle and may retain the mounting support. The mounting support in a crash event can move relative to the sliding capsule secured on the chassis of the motor vehicle. The sliding capsule may include a cylindrical section that extends through the open elongated hole. The mounting support may be retained on the sliding capsule by a retaining ring pressed onto the cylindrical section.

### TECHNICAL FIELD

The present invention concerns a steering column for a motor vehicle, which comprises a mounting support with at least one open elongated hole and at least one sliding capsule arranged in the open elongated hole for securing the mounting support on the chassis of the motor vehicle.

### PRIOR ART

In the field of steering columns for motor vehicles, various systems are known for the absorption of crash energy. Thus, for example, telescopic steering columns are known, in which a support unit which can be connected to the chassis of the motor vehicle and a displacement unit retained on the support unit are provided, wherein the displacement unit is arranged so that it can move relative to the support unit in order to provide a yielding of the steering wheel in event of a crash by a corresponding displacement of the displacement unit relative to the support unit connected to the chassis. Upon displacement of the displacement unit relative to the support unit, crash energy can be absorbed through an energy absorption element. Various energy absorption elements are known here, such as those in the form of bending tabs, bending wires, bending tear tabs or crash creases, to mention only a few possibilities.

An alternative concept for improving the crash behavior of a steering column involves a mounting support, on which the steering spindle is retained and able to rotate in an envelope pipe or a steering bracket. The mounting support is secured by sliding capsules to the chassis of the motor vehicle, the sliding capsules being lead through open elongated holes. In event of a crash, the mounting support together with the other components of the steering column accommodated on it is displaced relative to the sliding capsules secured firmly to the chassis of the motor vehicle along the open elongated holes. If the open elongated hole is open in a direction opposite the intended direction of vehicle movement, the mounting support after running through the displacement distance dictated by the open elongated hole slips out from the retention formed by the sliding capsules and then moves freely or also continues to be guided by separate guiding devices. The sliding capsules provide a predetermined breakaway level, which needs to be overcome in order to allow a displacement of the mounting support relative to the sliding capsules. In event of a crash, owing to the channeling of force into the steering column, a relative movement then occurs between the mounting support with the steering column and the sliding capsules fixed to the vehicle. The mounting support slides accordingly out from the sliding capsules when the predetermined breakaway force has been surpassed.

From EP 1 602 551 A1 for example there is known a steering column with sliding capsules, which are captively previously secured by means of a deformable ring or a corrugated washer on the mounting support, and then during the actual mounting of the steering column on the chassis of the motor vehicle the tightening torque of the screw fastening the respective sliding capsule on the chassis of the motor vehicle can be used for an adjustment in terms of its clamping force and thus also in terms of the breakaway force. Accordingly, a precisely predetermined tightening torque of the respective screw fastening the sliding sleeves on the chassis of the motor vehicle must be dictated in order to provide a defined breakaway force.

Presentation of the Invention

Starting from the known prior art, one problem which the present invention proposes to solve is to indicate a steering column for a motor vehicle in which the breakaway force of the sliding capsule of the mounted steering column can be adjusted even more reliably.

This problem is solved by a steering column with the features of claim 1. Advantageous modifications will appear in the subclaims.

Accordingly, a steering column for a motor vehicle is proposed, comprising a mounting support with at least one open elongated hole and at least one sliding capsule arranged in the open elongated hole, which can be secured on the chassis of the motor vehicle for the retaining of the mounting support, wherein the mounting support in event of a crash can move relative to the sliding capsule secured on the chassis of the motor vehicle and wherein the sliding capsule has a cylindrical section, which extends through the open elongated hole. According to the invention, the mounting support is retained on the sliding capsule by means of a retaining ring pressed onto the cylindrical section. By cylindrical section is meant in the sense of the invention any cylindrical profile. Thus, it can be a cylinder with a square, rectangular, or other polygonal base surface, as well as a cylinder with an elliptical base surface. Preferably, however, the cylindrical section is configured as a circular cylinder (=cylinder with circular base surface) or a rectangular cylinder (=cylinder with rectangular base surface) or a square cylinder (=cylinder with square base surface).

Because the sliding capsule is retained on the mounting support by means of a retaining ring pressed onto the cylindrical section, the press-on force of the retaining ring can be used to dictate a given clamping force by which the mounting support is retained on the sliding capsule and thus also a given breakaway force.

Thus, in this way it is possible to adjust the breakaway force of the sliding capsule independently of the actual mounting of the mounting support on the chassis of the motor vehicle, since the sliding capsule with the mounting support is retained only by the retaining ring pressed onto the cylindrical section. Thus, it is unnecessary to provide an additional pretensioning by applying a defined tightening torque to a screw securing the sliding capsule on the chassis. Instead, the clamping force with which the sliding capsule and the retaining ring hold the mounting support and thus also the breakaway force of the sliding capsule from the open elongated hole is independent of the particular tightening torque of the screw securing the sliding capsule.

In order to provide the best defined breakaway force possible, the retaining ring is preferably pressed with a predetermined press-on force onto the cylindrical section. By providing the predetermined press-on force, a defined clamping force can be exerted on the mounting support, which accordingly determines the breakaway force. The breakaway force here is independent of the actual mounting of the steering column and substantially dependent only on the press-on force.

An even further decoupling of the breakaway force of the steering column from the actual mounting situation is achieved in that the retaining ring is pressed onto the cylindrical section of the sliding capsule on the side of the mounting support facing away from the chassis. As a result, no jamming of the retaining ring occurs, even inadvertently, and no increasing of the press-on force of the retaining ring on the sliding capsule during the mounting process. The retaining ring is typically arranged on the bottom side of the mounting support. However, it is also conceivable and possible to arrange the retaining ring on the top side of the mounting support. The application of a predetermined tightening torque during the mounting process, as is known in the prior art, is accordingly eliminated. A connection section of the sliding capsule is accordingly arranged on the top side of the mounting support and thus a direct connection to the chassis is made possible. The tightening torque of the screw securing the sliding capsule on the chassis is thus sustained entirely by the sliding capsule itself, and there is no influence on the retaining ring. As a result, the breakaway force is independent of the tightening torque of the screw.

Preferably a washer is arranged between the retaining ring and the mounting support, so that a defined frictional behavior can be provided between the sliding capsule and the washer, which is independent of the respective deformation and contour of the retaining ring. In alternative embodiments, instead of the washer a spring element and/or a strip of sheet metal can also be so arranged. The metal strip so arranged can be designed directly as an energy absorption means, for example in the form of a bending strip or a bending tear tab.

The retaining ring provides a defined breakaway force of the mounting support relative to the sliding capsule. In other words, by the pressing of the retaining ring onto the cylindrical section of the sliding capsule a defined retention force or breakaway force can be adjusted.

The cylindrical section of the sliding capsule preferably has an axial extension which is larger than the combination of the material thickness of the mounting support and the axial height of the retaining ring and, when a washer is present, also the material thickness of the washer. In other words, the cylindrical section in the mounted state extends beyond the outermost end of the retaining ring, so that a screw securing the sliding capsule on the chassis of the motor vehicle or its screw head can find a purchase there, without influencing the clamping force between collar section of the sliding capsule and the retaining ring.

In another preferred configuration, between a lower end of the cylindrical section and the retaining ring there is provided a free height of the cylindrical section, not occupied by other components. Thus, an interaction of the retaining ring with a screw securing the sliding capsule on the chassis can be safely avoided during the mounting process, so that the breakaway force of the mounting support relative to the sliding capsule can be dictated solely through the press-on force when pressing the retaining ring in place.

In one preferred modification, the sliding capsule has a collar section, which is arranged on the side of the mounting support facing the chassis for the connecting of the sliding capsule to the chassis of the motor vehicle and between a bottom side of the collar section and the retaining ring a clamping force is exerted on the mounting support, which determines the breakaway force.

Preferably a coating is formed on the sliding capsule in order to provide a defined sliding behavior and a reduced corrosion behavior of the sliding capsule.

The aforementioned problem is furthermore solved by a method for production of a steering column with the features of claim 10.

Accordingly, a method is proposed for the production of a steering column. According to the invention, a cylindrical section of a sliding capsule is arranged in an open elongated hole of a mounting support and a retaining ring is pressed with a predetermined press-on force onto the cylindrical part of the sliding capsule.

By pressing the retaining ring in place with a predetermined press-on force, a retaining of the sliding capsule on the mounting support with a defined breakaway force can be accomplished. The breakaway force can be adjusted only through the press-on force of the retaining ring, and is independent of any tightening torque of a screw retaining the sliding capsule on the chassis of the motor vehicle.

### BRIEF DESCRIPTION OF THE FIGURES

Further preferred embodiments and aspects of the present invention will be explained more closely by the following description of the figures. There are shown:

FIG. 1: a schematic perspective representation of a steering column in a first sample embodiment;

FIG. 2: a schematic perspective representation of a mounting support of the steering column from FIG. 1;

FIG. 3: a sliding capsule with a washer and a retaining ring in a disassembled perspective representation;

FIG. 4: a schematic perspective representation of the production of the steering column;

FIG. 5: a schematic perspective representation of another steering column;

FIG. 6: a schematic side view of another steering column with an energy absorption element; and

FIG. 7: a schematic cross-sectional view through a mounting support with installed sliding capsule and pressed-on retaining ring; and

FIG. 8: an alternative embodiment of the sliding capsule of FIG. 3 with a square cylindrical configuration.

### DETAILED SPECIFICATION OF PREFERRED SAMPLE EMBODIMENTS

In what follows, preferred sample embodiments will be described with the aid of the figures. The same, similar, or equivalent elements in the different figures are designated here with identical reference numbers and a repeat description of some of these elements will be omitted from the following specification, in order to avoid redundancies.

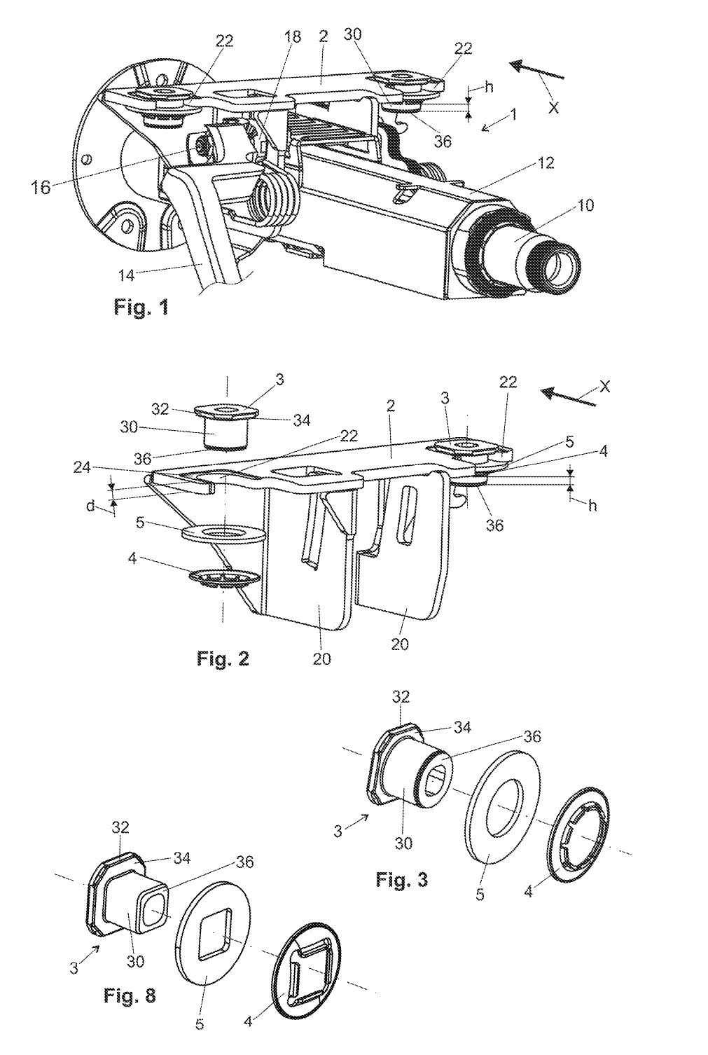

FIG. 1 shows a steering column 1 in a schematic perspective representation. The steering column 1 comprises a steering spindle 10, which in a manner known per se is retained and able to rotate in a steering bracket 12, and which is designed to transmit a steering torque from a steering wheel to a steering gear, for example, by way of a steering shaft.

The steering bracket 12 in the embodiment shown is retained in its variable position on a mounting support 2. The steering bracket 12 is arranged here so that it can swivel between two cheeks 20 of the mounting support 2 and can move axially along the axis of the steering spindle 10. The mounting support 2 is again shown separately and in a schematic perspective view in FIG. 2, from which the arrangement of the cheeks 20 is evident. By a tensioning lever 14, which acts via a cam mechanism 18 on a tensioning axle 16, the position of the steering column 1 can be locked in a position chosen by the driver.

The mounting support 2 serves to connect the overall steering column 1 to the chassis of a motor vehicle. For this, the mounting support 2 has two open elongated holes 22, which are open against the intended direction of vehicle movement X and by which the connection of the mounting support 2 to the chassis of the motor vehicle is accomplished.

For the connection of the mounting support 2 to a connection section on the chassis of the motor vehicle, a sliding capsule 3 which is fixed in the mounted state to the chassis of the motor vehicle is inserted into the open elongated hole 22. The sliding capsule 3 has a cylindrical section 30 and a collar section 32. The collar section 32 in the sample embodiment shown is arranged on the top side of the mounting support 2, which in the mounted state is directed toward the respective connection section on the chassis of the motor vehicle. Accordingly, the collar section 32 of the sliding capsule 3 lies against the chassis of the motor vehicle when the mounting support 2 is mounted in the motor vehicle.

The cylinder-shaped section 30 extends from the collar section 32 through the open elongated hole 22 of the mounting support 2 and extends further to the bottom side, i.e., the side of the mounting support 2 facing away from the chassis of the motor vehicle. The mounting support 2 is retained on the sliding capsule 3 by means of a defined retaining ring 4 pressed onto the cylindrical section 30 of the sliding capsule 3. Thanks to the retaining ring 4 pressed on with a defined press-on force, a defined clamping force can be achieved between the retaining ring 4 and the bottom side 34 of the collar section 32, by means of which the mounting support 2 is retained on the sliding capsule 3.

The invention can also be used in a reversed configuration, in which the collar section is arranged on the bottom side of the mounting support and the retaining ring on the top side of the mounting support.

Since the mounting support 2 is retained with a defined clamping force, which is defined by the defined press-on force of the retaining ring 4 against the cylindrical section 30 of the sliding capsule 3, a defined breakaway force of the sliding capsule 3 for the relative movement of the mounting support 2 in the intended direction of vehicle movement X can also be provided. In this way, it is possible to define, in event of a crash, the breakaway force to be overcome, after which the mounting support 2 moves along the open elongated hole 22 and ultimately becomes disengaged from the sliding capsule 3. Thus, the dependency of the breakaway force on the mounting or on the tightening torque of a screw led through the sliding capsule 3, as known in the prior art, no longer occurs. Instead, the breakaway force in the sample embodiment shown is substantially defined by the providing of the retaining ring 4 pressed on with a defined press-on force and it does not change with different tightening torques of the screw securing the sliding capsule 3 on the chassis of the motor vehicle.

In order to provide an even more precisely defined breakaway force in the sample embodiment shown, a washer 5 is provided between the retaining ring 4 and the sliding capsule 3. Thanks to the washer 5, a corresponding surface pressure can be achieved over the surface of the washer 5 which is independent of the geometrical shape of the retaining ring 4 as well as the possible deformation of the retaining ring 4 produced by the pressing on.

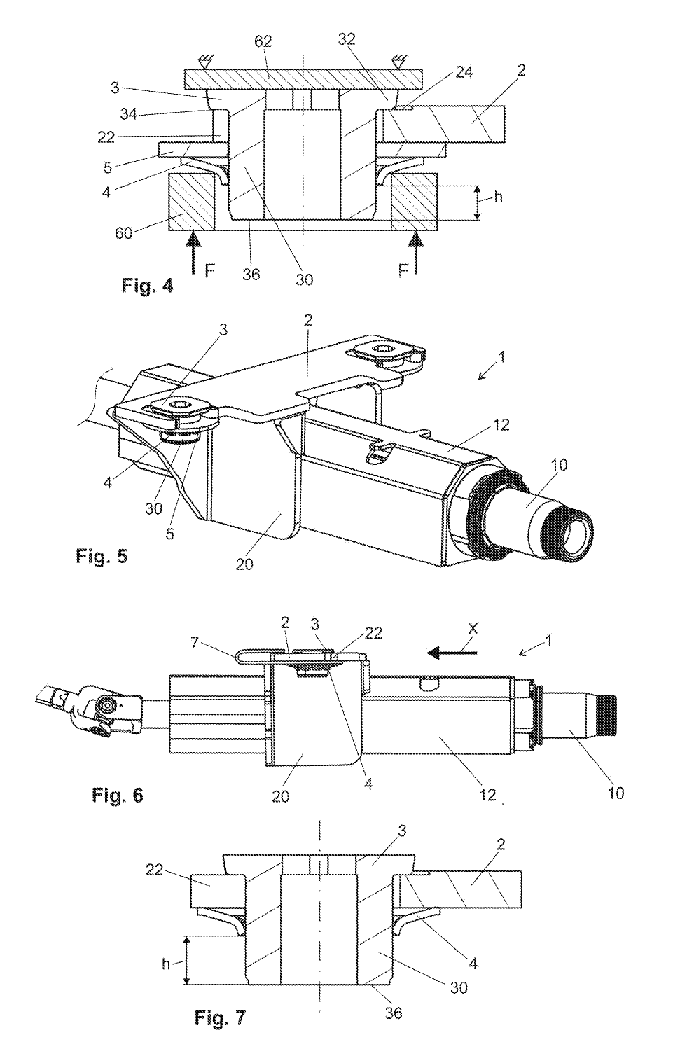

The retaining ring 4 is pressed onto the cylindrical section 30 of the sliding capsule 3 under controlled force. This process is basically illustrated in FIG. 4, showing a press-on tool 60 in a schematic representation for the mounting of the sliding capsule 3, which applies a predetermined press-on force F to the retaining ring 4. The collar section 32 of the sliding capsule 3, which in the mounted state lies against the chassis of the motor vehicle, at the same time lies here against an anvil 62 for the defined pressing on of the retaining ring 4. The retaining ring 4 accordingly exerts a press-on force on the sliding capsule 3, pretensioning the collar section 32 in the direction of the retaining ring 4, which provides a firm grip of the sliding capsule 3 on the mounting support 2 and especially in the open elongated hole 22 of the mounting support 2. The collar section 32 lies by its bottom side 34 against a surface 24 of the mounting support 2, while a defined frictional behavior is provided accordingly between the bottom side 34 of the collar section 32 and the surface 24 of the mounting support 2.

The press-on force F applied by means of the tool 60 with respect to the anvil 62 accordingly provides a defined clamping force between collar section 32 of the sliding capsule 3 and retaining ring 4, so that already before the mounting of the steering column 1 on the chassis of the motor vehicle defined adjustment of the breakaway force can be achieved, which is independent of the subsequent mounting process.

In event of a crash, a force is applied in the direction of vehicle movement X to the mounting support 2 by the steering wheel arranged on the steering spindle 10 upon impact of the upper body or head of the driver. Since the open elongated hole 22 is open opposite the direction of vehicle movement X, after surpassing a breakaway force determined by the pretensioning of the retaining ring 4 the mounting support 2 moves forward relative to the sliding capsule 3 in the direction of vehicle movement X and then slips out of engagement with the sliding capsule 3. Accordingly, the steering column 1 is drawn back in event of a crash, wherein the mounting support 2 of the steering column 1 moves forward relative to the sliding capsule 3 secured to the chassis of the motor vehicle and accordingly the rearward open elongated holes 22 after traveling a predetermined displacement path, which is determined by the length of the open elongated hole 22, is disengaged from the sliding capsules 3.

The invention can also be applied in cases when the sliding capsule interacts with defined pressure points on pressure points at the edges of the elongated hole. Already with a very short displacement, when the pressure points are no longer in contact, the steering column can be released here from the mounting support. Alternatively, the sliding surfaces can also be wedge-shaped, so that the tensioning force between sliding capsule and mounting support is greatly diminished already after a few millimeters of displacement, as is implemented for example in EP1077861B1.

As is seen for example from the mounted state of the sliding capsule 3 with the retaining ring 4, shown at the right side in FIG. 2, the lower end 36 of the cylindrical section 30 of the sliding capsule 3 is designed to extend beyond the outermost dimension of the retaining ring 4. In other words, the cylindrical section 30 extends between its lower end 36 and the retaining ring 4 across a free height h, in which no other components are mounted, so that the cylindrical section 30 extends beyond the retaining ring 4. In this way, it is possible to secure the sliding sleeve 3, for example by means of a screw not shown here, immovably to the chassis of a motor vehicle, while the tightening torque of the particular screw will then have no influence at all on the clamping of the mounting support 2 between collar section 32 and retaining ring 4. Namely, the screw will not come into engagement or contact with the pressed-on retaining ring 4, since the axial height of the cylindrical section 30 is greater than the material thickness d of the mounting support 2 in combination with the material thickness of the washer 5 and the height of the retaining ring 4 in the pressed-on state.

Accordingly, the cylindrical section 30 of the sliding capsule 3 extends beyond the outermost extent of the retaining ring 4, so that even when a corresponding screw is tightened for the securing of the sliding capsule 3 on the chassis of the motor vehicle no change occurs in the retaining force of the sliding capsule 3 relative to the mounting support 2. In other words, the corresponding screw for the securing of the sliding capsule 3 does not lie against the retaining ring 4 and thus neither can it have an effect on it.

The clamping force exerted by the screw only compresses the sliding capsule 3 itself, but has no influence at all on the clamping force exerted between sliding capsule 3 and retaining ring 4 on the mounting support 2. Thus, the breakaway force of the mounting support 2 from the sliding capsule 3 is independent of the particular tightening torque of the screw retaining the sliding capsule 3.

Preferably, the sliding capsule 3 is provided with a surface coating, in order to be able to provide a predetermined sliding behavior or frictional behavior and thus a defined breakaway force in reliable manner. In this way, a corrosion of the sliding capsule 3 can also be reduced or prevented, so that the predetermined breakaway force even under extreme conditions or after an aging of the motor vehicle or the steering column can be maintained.

FIG. 5 shows another steering column 1 with a similar layout to the steering column 1 shown in FIGS. 1 and 2, while the steering bracket 12 in this steering column 1 cannot vary its position relative to the mounting support 2. Accordingly, it is a non-adjustable steering column 1. This non-adjustable steering column 1 can be secured in the same way as described above by means of the mounting support 2 on the chassis of the motor vehicle so that sliding capsules 3 are retained via a retaining ring 4 pressed on with a predetermined press-on force on the sliding capsule 2 and the cylindrical section 30 of the sliding capsule 3 is configured so that even during the mounting of the sliding capsule 3 on the chassis of the motor vehicle there is no influencing of the clamping force between the collar section 32 of the sliding capsule 3 and the pressed-on retaining ring 4.

FIG. 6 shows another steering column 1, which in its basic design resembles the steering column of FIG. 5. In particular, the steering bracket 12 cannot change its position relative to the mounting support 2.

In event of a crash, the force transmitted via the steering spindle 10 to the steering bracket 12 is transferred to the cheeks 20 of the mounting support 2 so that, after surpassing a predetermined breakaway force, the steering column 1 is moved forward in the direction of vehicle movement X relative to the sliding capsule 3 secured on the chassis of the motor vehicle and accordingly the sliding capsule 3 slips out from the open elongated hole 22 toward the rear.

In the sample embodiment shown in FIG. 6, a further energy absorption element 7 is shown, which is provided in the form of a bending strip, being secured on the sliding capsule 3 likewise by means of the retaining ring 4. When the mounting support 2 is moved forward on account of the applying of an increased force in event of a crash in the direction of vehicle movement X, the mounting support 2 is accordingly pressed into the energy absorption element 7, so that the bending strip is gradually unwound. Thanks to the corresponding dynamic reshaping of the energy absorption element 7, an energy absorption occurs.

In place of the bending strip, a bending tear tab or other energy absorption part can also be provided as the energy absorption element.

FIG. 7 is a schematic cross-sectional representation through a mounting support 2, comprising an open elongated hole 22 in which a sliding capsule 3 is arranged, which is retained by means of a retaining ring 4 pressed on with a defined press-on force. No washer is provided in the sample embodiment shown in FIG. 7.

FIG. 8 shows an alternative embodiment of the sliding capsule, in which the cylindrical section 30 is configured as a square cylinder. Accordingly, the retaining ring 4 also has a corresponding shape.

All individual features which are represented in the individual sample embodiments can be combined with each other and/or exchanged, so far as is applicable, without leaving the scope of the invention.

### LIST OF REFERENCE NUMBERS

1 Steering column
10 Steering spindle
12 Steering bracket
14 Tensioning lever
16 Tensioning axle
18 Cam drive
2 Mounting support
20 Cheek
22 Elongated hole
24 Surface
3 Sliding capsule
30 Cylindrical section
32 Collar section
34 Bottom side
36 Lower end of cylindrical section
4 Retaining ring
5 Washer
60 Press-on tool
62 Anvil
7 Energy absorption element
X Direction of vehicle movement
d Material thickness of mounting support
F Press-on force
h Free height

1.-10. (canceled)

11. A steering column for a motor vehicle comprising:
a mounting support including an open elongated hole;
a sliding capsule disposed in the open elongated hole and securable on a chassis of a motor vehicle to retain the mounting support, the sliding capsule including a cylindrical section that extends through the open elongated hole, wherein in a crash event the mounting support is movable relative to the sliding capsule secured on the chassis of the motor vehicle; and
a retaining ring that is pressed onto the cylindrical section of the sliding capsule and retains the mounting support on the sliding capsule.

12. The steering column of claim 11 wherein the retaining ring is pressed onto the cylindrical section with a predetermined press-on force.

13. The steering column of claim 11 wherein the retaining ring is positioned on the cylindrical section of the sliding capsule on a side of the mounting support facing away from the chassis.

14. The steering column of claim 11 further comprising a washer disposed between the retaining ring and the mounting support.

15. The steering column of claim 11 wherein the retaining ring provides a defined breakaway force of the mounting support relative to the sliding capsule.

16. The steering column of claim 11 wherein the cylindrical section of the sliding capsule has an axial extension that is larger than a combination of a thickness of the mounting support and an axial height of the retaining ring.

17. The steering column of claim 11 further comprising a washer disposed between the retaining ring and the mounting support, wherein the cylindrical section of the sliding capsule has an axial extension that is larger than a combination of a thickness of the mounting support, an axial height of the retaining ring, and a thickness of the washer.

18. The steering column of claim 11 wherein a free height exists between a lower end of the cylindrical section and the retaining ring, wherein no components occupy the free height of the cylindrical section.

19. The steering column of claim 11 wherein the retaining ring provides a defined breakaway force of the mounting support relative to the sliding capsule, wherein the sliding capsule comprises a collar section that is positioned on a side of the mounting support facing the chassis for connecting the sliding capsule to the chassis of the motor vehicle, with an upper side of the collar section facing away from the mounting support and a bottom side of the collar section contacting the mounting support, wherein a clamping force that determines the defined breakaway force is exerted on the mounting support between the bottom side of the collar section and the retaining ring.

20. The steering column of claim 11 wherein a surface of the sliding capsule is coated with a surface layer.

21. The steering column of claim 11 wherein a surface of the sliding capsule has been subjected to a special surface treatment.

22. A method for producing the steering column of claim 11, the method comprising:
positioning the cylindrical section of the sliding capsule in the open elongated hole of the mounting support; and
pressing the retaining ring with a predetermined force onto the cylindrical part of the sliding capsule.

23. A method for producing a steering column, the method comprising:
positioning a cylindrical section of a sliding capsule in an open elongated hole of a mounting support; and
pressing a retaining ring with a predetermined force onto the cylindrical part of the sliding capsule, wherein the retaining ring retains the mounting support on the sliding capsule.

24. The method of claim 23 further comprising securing the sliding capsule to a chassis of a motor vehicle, wherein in a crash event the mounting support is movable relative to the sliding capsule secured to the chassis of the motor vehicle.
